(19) United States
(12) Patent Application Publication
(10) Pub. No.: US 2013/0044144 A1
(43) Pub. Date: Feb. 21, 2013

(54) LIQUID CRYSTAL DISPLAY AND DRIVING METHOD THEREOF

(71) Applicants: Chengming He, Shenzhen (CN); Hung-Iung Hou, Shenzhen (CN)

(72) Inventors: Chengming He, Shenzhen (CN); Hung-Iung Hou, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/375,232

(22) PCT Filed: Oct. 20, 2011
(86) PCT No.: PCT/CN2011/081012

§ 371 Date: Nov. 30, 2011

(30) Foreign Application Priority Data
Aug. 19, 2011 (CN) 20110240016.6

(51) Int. Cl. G09G 3/36; G09G 5/10

(52) U.S. Cl. 345/690; 345/89

(57) ABSTRACT

A driving method for a liquid crystal display includes the following steps: before the switching operation from a preceding frame to a next frame, looking up a preset second lookup table to obtain an actual gray scale of the preceding frame based on frame data of the preceding frame, the frame data of the preceding frame at least includes gray scale; according to the actual gray scale of the preceding frame and a predetermined gray scale of the next frame, looking up a preset first lookup table to obtain an overdrive gray scale for the switching operation from the preceding frame to the next frame ; performing an overdrive operation according to the overdrive gray scale. With the driving method, the gray scale can be corrected by the second lookup table, which improves the display effect of the liquid crystal display.

### BACKGROUND

1. Technical Field

The present disclosure relates to liquid crystal displaying technologies, and particularly, to a liquid crystal display and a driving method thereof.

2. Description of Related Art

Overdrive (OD) operations are often performed for eliminating residual images in liquid crystal displays (LCDs). The LCD includes a number of liquid crystal molecules. Each liquid crystal molecule is capable of respectively keeping in a number of stable states each which corresponds to a predetermined voltage. When a driving voltage is applied to the LCD, each liquid crystal molecule begins to rotate after a response time. The higher the driving voltage is, the higher the rotating speed of the liquid crystal molecule is, and the shorter the response time is. Under the driving voltage, the liquid crystal molecule is capable of switching from an initial gray scale level (gray scale) of a preceding frame to a target gray scale of a next frame after the response time. When the target gray scale changes, the driving voltage changes accordingly, which further results in the change of the rotating angle and the changes of the response time. In a conventional LCD, the driving voltage is the same as the predetermined voltage in a conventional LCD, while in a LCD applying the overdrive operation, the driving voltage is often higher than the predetermined voltage to speed up the rotating speed of the liquid crystal molecule. The driving voltage goes down to be the same as the predetermined voltage after the liquid crystal molecule switches to the target gray scale for keeping the liquid crystal molecule in the stable state. In this state, the response time thus is shortened and substantially unchanged even the target gray scale is changed.

In the overdrive operation, electric fields are supplied to allow the driving voltage higher than the predetermined voltage to be applied to the liquid crystal molecule. Therefore, the liquid crystal molecule is capable of rotating over a predetermined angle in a shorter response time, such as 8 ms or shorter. For example, assuming the initial gray scale of the preceding frame is 0 and the target gray scale of the next frame is 128, and assuming that an initial driving voltage corresponding to the initial gray scale is 0 volts and a target driving voltage corresponding to the target gray scale is 3 volts, for driving the liquid crystal molecule to switch to the target gray scale from the initial gray scale, the driving voltage changing from 0 volts to 3 volts is applied to the liquid crystal molecule. However, in this situation, the liquid crystal molecule cannot rotate in a speed high enough.

Generally, a driving voltage changing from 0 volt to 4 volts (assuming that 4 volts corresponds to a third gray scale 150) is applied to the liquid crystal molecule to speed up the rotating speed of the liquid crystal molecule. In this situation, a lookup table (LUT) is needed for obtaining an overdrive gray scale 150 to allow the target gray scale 128 to be replaced with the overdrive gray scale 150.

Referring to FIG. 1, without the performance of the overdrive operation, the brightness of the liquid crystal molecule changes slowly under the driving voltage sequentially changing from 0 volt to 3 volts.

Referring to FIG. 2, with the performance of the overdrive operation, the brightness of the liquid crystal molecule changes rapidly when being applied by the driving voltage sequentially changing from 0 volts to 4 volts and further to 3 volts.

Referring to FIG. 3, in the conventional overdrive operation, a control circuit of the LCD is capable of searching a suitable overdrive gray scale which can drive the liquid crystal molecule to rotate in a higher rotating speed according to the change of the signals of pixels of the LCD. Take the switch from the gray scale of 0 to the gray scale of 128 as an example, the suitable overdrive gray scale corresponding to the gray scale of 120 is 150.

Although the overdrive operation has been applied in LCDs for a long time, there are still some problems especially when the overdrive operation is applied in a LCD having a high refresh frequency. In a conventional LCD having a refresh frequency of 60 HZ, the time span of each frame is long enough to allow the liquid crystal molecule to response in the time span. Therefore, the overdrive operation can be performed and the brightness of the LCD can reach a desired brightness level. However, in a LCD having a refresh frequency of 240 HZ, the time span of each frame is shortened. Although the rotating speed of the liquid crystal molecule is sped up accordingly under the overdrive operation, the shortened time span still prevents the liquid crystal molecule from rotating over the predetermined angle to allow the brightness therefore to reach 90% of the desired brightness level in the time span. Therefore, the target of the overdrive operation cannot be realized and the brightness of the displayed image is not ideal.

Take the LCDs of refresh frequency of 240 HZ for example, the time span of each frame lasts about 4.15 ms which should be 16.6 ms when the refresh frequency of the LCD is 60 HZ. Since the time period needed for the liquid crystal molecule to switch to the target gray scale from the initial gray scale is often about 5 ms, therefore, the switching operation still is not finished when the overdrive operation finishes and the overdrive voltage is no longer applied to the liquid crystal molecules. After the overdrive operation, the rotating speed of the liquid crystal molecules slows down, preventing the liquid crystal molecule from rotating over the predetermined angle and further preventing the overdrive operation from reaching the predetermined target.

Referring to FIG. 4, to the LCD having the refresh frequency of 60 HZ, when the liquid crystal molecule switches from the initial gray scale 0 to the target gray scale 128 under the driving voltage sequentially changing from 0 volt to 4 volts and further to 3 volts, the liquid crystal molecule is capable of rotating over the predetermined angle in the time span to allow the brightness of the LCD to reach 90% of the desired brightness level. According to the chart shown in FIG. 4, it is concluded that with the performance of the overdrive operation, the time period needed for changing the brightness of the LCD to 90% of the desired brightness level from 10% thereof is At. While without the performance of the overdrive operation, the time period needed for changing the brightness of the LCD to 90% of the desired brightness level from 10% thereof is Δt′(Δt′<Δt).

Referring to FIG. 5, to the LCD having the refresh frequency of 60 HZ, the time span of each frame is 16.6 ms, while to the LCD having the refresh frequency of 240 HZ, the time span is shortened to be one forth of 16.6 ms, that is, 4.15 ms. In the 4.15 ms, the liquid crystal molecule cannot rotate over the predetermined angel to allow the gray scale to be changed to 128 (the time period for the liquid crystal molecule changing from the initial gray scale 0 to the target gray scale 128 is longer than 5 ms)

With the frequent use of the LCD having a high refresh frequency, it is important to improve the overdrive operation and to improve the display effect of the LCD.

### SUMMARY

A driving method for driving a liquid crystal display is provided. The driving method includes the following steps:
before a switching operation from a preceding frame to a next frame, looking up a preset second lookup table to obtain an actual gray scale of the preceding frame according to frame data of the preceding frame, the frame data of the preceding frame at least comprising a gray scale of the preceding frame;
according to the actual gray scale of the preceding frame and a predetermined gray scale of the next frame, looking up a preset first lookup table to obtain an overdrive gray scale corresponding to the switching operation from the preceding frame to the next frame;
performing an overdrive operation according to the overdrive gray scale.

Preferably, the driving method further includes the step of setting the first lookup table and the second lookup table before the step of obtaining the actual gray scale of the preceding frame from the second lookup table.

Preferably, the first lookup table stores the overdrive gray scale of the overdrive operation corresponding to the switching operation from the preceding frame to the next frame, and the second lookup table stores contrary information used for correcting the gray scale of the liquid crystal molecule in the overdrive operation of the LCD having a high refresh frequency.

Preferably, the information stored in the second lookup table is obtained by experimental detects.

Preferably, the driving method further includes the following steps:
comparing the actual gray scale of the preceding frame with a target gray scale of the next frame to obtain a difference therebetween;
judging whether the difference is smaller than a predetermined value or not;
finishing the overdrive operation if the difference is smaller than the predetermined value.
   Preferably, the predetermined value is 5.

A liquid crystal display for applying the driving method is further provided. The liquid crystal display includes a preset first lookup table, a preset second lookup table, a gray scale obtaining unit, an overdrive gray scale obtaining unit, and an overdrive operation unit. The gray scale obtaining unit is used for obtaining an actual gray scale of a preceding frame from the second lookup table according to frame data of the preceding frame before a switching operation from the preceding frame to the next frame, and the frame data at least includes a gray scale of preceding frame. The overdrive gray scale obtaining unit is sued for obtaining an overdrive gray scale used in the switching operation from the preceding frame to the next frame according to the actual gray scale of the preceding frame and a target gray scale of the next frame. The overdrive operation unit is used for performing the overdrive operation according to the overdrive gray scale.

Preferably, the liquid crystal display further includes a setting unit for setting the first lookup table and the second lookup table.

Preferably, the first lookup table stores the overdrive gray scale of the overdrive operation corresponding to the switching operation from the preceding frame to the next frame, and the second lookup table stores contrary information used for correcting the gray scale of the liquid crystal molecule in the overdrive operation of the LCD having a high refresh frequency.

Preferably, the information stored in the second lookup table is obtained by experimental detects.

Preferably, the liquid crystal display further includes a comparing unit for comparing the actual gray scale of the preceding frame with the target gray scale of the next frame to obtain a difference therebetween; judging whether the difference is smaller than a predetermined value or not; and finishing the overdrive operation if the difference is smaller than the predetermined value.

Preferably, the predetermined value is 5.

Another liquid crystal display for applying the driving method is further yet provided. The liquid crystal display includes a setting unit, a gray scale obtaining unit, an overdrive gray scale obtaining unit, and an overdrive operation unit. The setting unit is used for setting a first lookup table and a second lookup table, the first lookup table storing the overdrive gray scale of the overdrive operation corresponding to a switching operation from the preceding frame to the next frame, and the second lookup table storing contrary information used for correcting the gray scale of the liquid crystal molecule in the overdrive operation of the LCD having a high refresh frequency. The gray scale obtaining unit is used for obtaining an actual gray scale of a preceding frame from the second lookup table according to frame data of the preceding frame before the switching operation from the preceding frame to the next frame, the frame data at least comprising a gray scale of preceding frame. The overdrive gray scale obtaining unit is used for obtaining an overdrive gray scale used in switching operation from the preceding frame to the next frame according to the actual gray scale of the preceding frame and a target gray scale of the next frame. The overdrive operation unit is used for performing the overdrive operation according to the overdrive gray scale.

Preferably, the information stored in the second lookup table is obtained by experimental detects.

Preferably, the liquid crystal display further includes a comparing unit for comparing the actual gray scale of the preceding frame with the target gray scale of the next frame to obtain a difference therebetween, judging whether the difference is smaller than a predetermined value or not; and finishing the overdrive operation if the difference is smaller than the predetermined value.

Preferably, the predetermined value is 5.

In the present disclosure, the actual gray scale of the preceding frame is corrected by the second lookup table and is compared with the target gray scale of the next frame N to obtain a difference therebetween. If the difference is smaller than the predetermined value, there is no overdrive operation is performed, which improves the display effect of the liquid crystal display.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view showing the change of the brightness of the liquid crystal molecule without the performance of the overdrive operation in a conventional liquid crystal display (LCD).

FIG. 2 is a schematic view showing the change of the brightness of the liquid crystal molecule with the performance of the overdrive operation in a conventional liquid crystal display (LCD).

FIG. 3 is a schematic view of a lookup table in the conventional overdrive operation showing the comparison between gray scales.

FIG. 4 is a schematic view showing the change of the brightness of the liquid crystal molecule of the LCD having the refresh frequency of 60 HZ with the performance of the overdrive operation.

FIG. 5 is similar to FIG. 4 but with the LCD having the refresh frequency of 240 HZ.

FIG. 6 is a flow chart of a driving method for a LCD in accordance with a first embodiment of the present disclosure.

FIG. 7 is a flow chart of a driving method for a LCD in accordance with a second embodiment of the present disclosure.

FIG. 8 is a schematic view showing a switching operation between two frames according to the driving methods of FIGS. 6 and 7.

FIG. 9 is a schematic view of a first lookup table of the driving method of FIGS. 6 and 7.

FIG. 10 is a schematic view of a second lookup table of the driving method of FIGS. 6 and 7.

FIG. 11 is a flow chart of a driving method for a LCD in accordance with a third embodiment of the present disclosure.

FIG. 12 is a schematic view showing a brightness of the LCD when being applied an overvalued overdrive voltage.

FIG. 13 is a schematic view of a LCD in accordance with a first embodiment of the present disclosure.

FIG. 14 is a schematic view of the LCD in accordance with a second embodiment of the present disclosure.

FIG. 15 is a schematic view of the LCD in accordance with a third embodiment of the present disclosure.

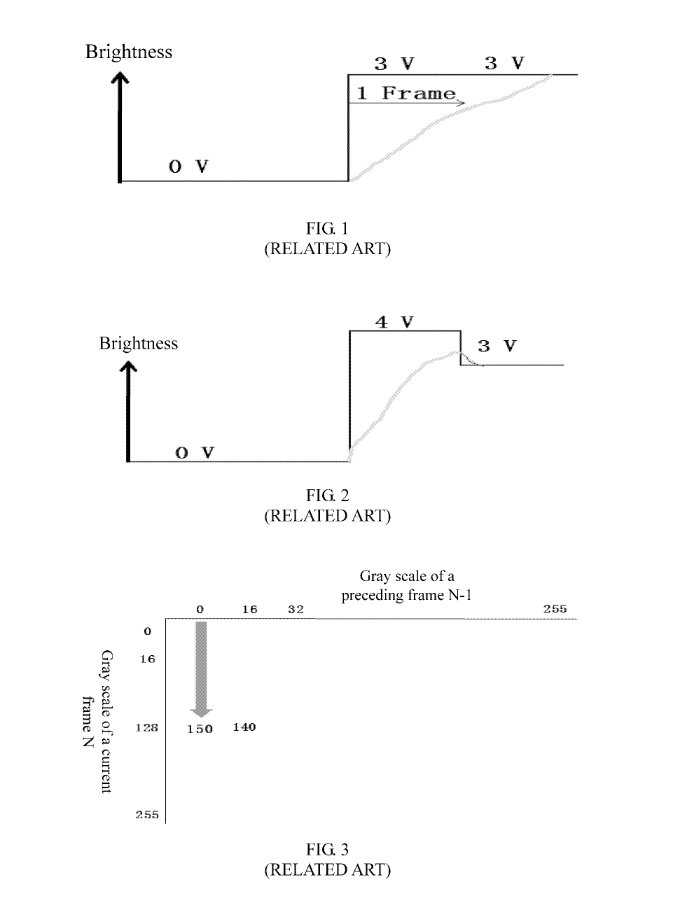

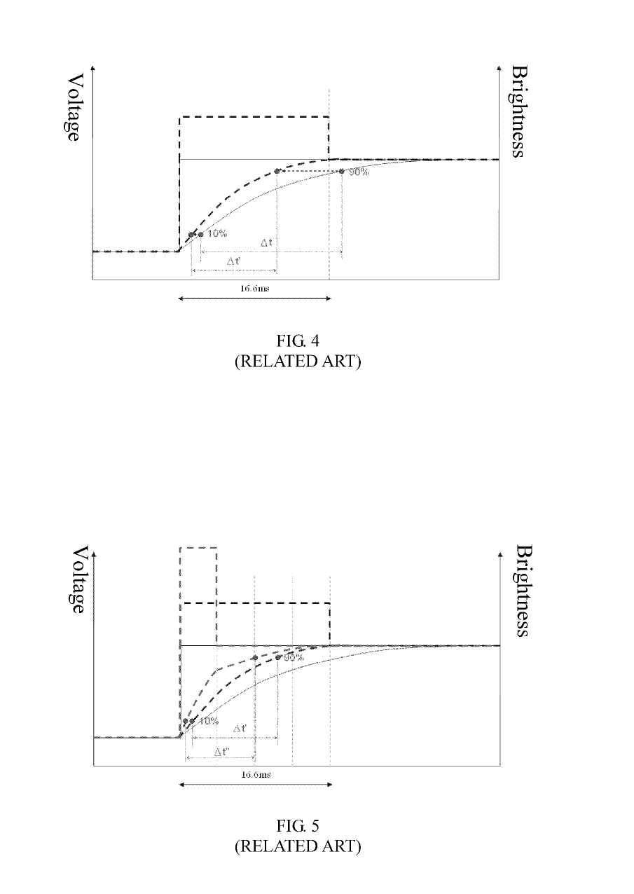

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

There are two ways can be used to solve the problem of the conventional overdrive operation:

On one hand, increasing a driving voltage to improve the response speed (higher rotating speed) of a liquid crystal molecule, the brightness of the liquid crystal molecules thus can reach 90% of a desired brightness level in a short time. However, the driving voltage cannot be increased to an unlimited degree.

On the other hand, prolonging a time period in which the overdrive operation is performed to allow the driving voltage to be applied to the liquid crystal molecule for a longer time. In actual situation, a preceding frame N−1 is compared with a next frame N to obtain a corresponding overdrive gray scale from a lookup table (LUT). For example, when the liquid crystal molecule switches from the a first gray scale 0 of the preceding frame N−1 to a second gray scale (target gray scale) 128 of a next frame N and further to a third gray scale 128 of a succeeding frame N+1 (0→128→128), the overdrive gray scale corresponding to the switching operation from the first gray scale 0 to the second gray scale 128 is 150, and the overdrive gray scale corresponding to the switching operation from the second gray scale 128 to the third gray scale 128 is 0. Since the liquid crystal molecule cannot rotate over the predetermined angle in the time period, the actual gray scale of the second gray scale cannot reach 128, which can be overcome in the present disclosure.

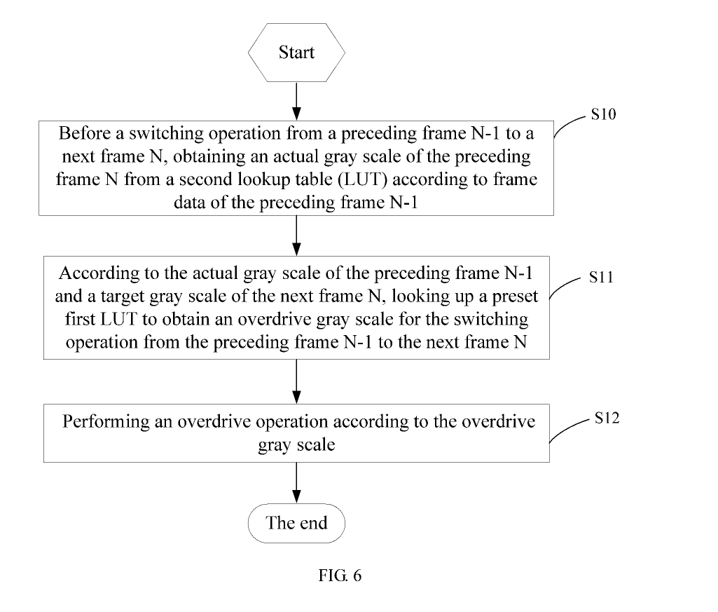

Referring to FIG. 6, a driving method of a liquid crystal display (LCD) is provided in accordance with a first embodiment of the present disclosure. The driving method includes the following steps:

In step S10, before the switching operation from the first gray scale of the preceding frame N−1 to the target gray scale of the next frame N, looking up a second lookup table (LUT) to obtain an actual gray scale of the preceding frame N−1 according to frame data of the preceding frame N−1, the frame data at least includes a gray scale of the preceding frame.

In step S11, according to the actual gray scale of the preceding frame N−1 and the target gray scale of the next frame N, looking up a first LUT to obtain an overdrive gray scale corresponding to the switching operation from the first gray scale to the target gray scale by looking up a first LUT.

In step S13, performing the overdrive operation according to the overdrive gray scale.

With the second LUT of the driving method of the present disclosure, the gray scale of the preceding frame N−1 is corrected, which improves the display effect of the LCD.

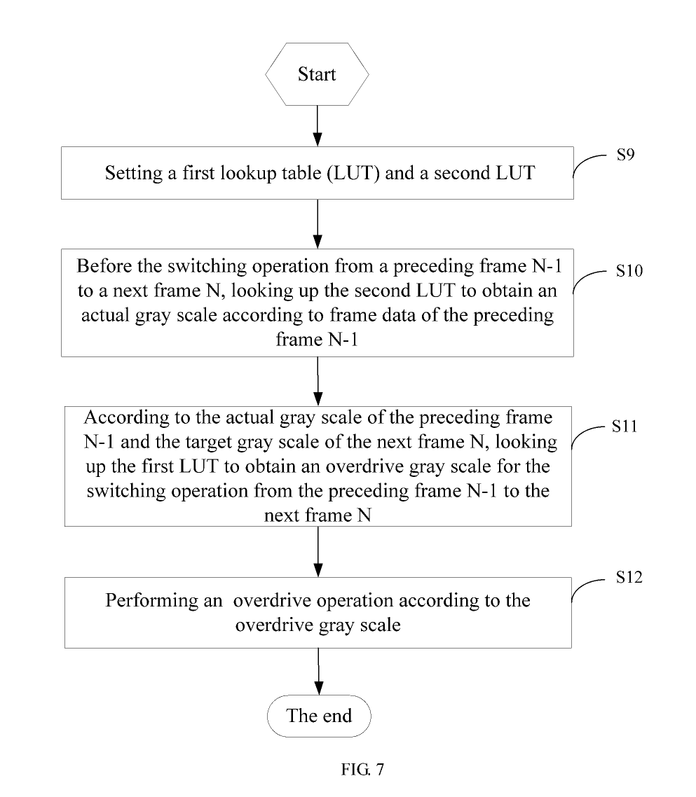

Referring to FIG. 7, in a second embodiment, the driving method further includes the following step:

In step S9, setting the first LUT and the second LUT in the LCD.

In some embodiments, the first LUT stores overdrive gray scales corresponding to gray scale switching operations. The first LUT can be a conventional LUT used in the conventional overdrive operation. In the overdrive operation, a corresponding overdrive gray value can be obtained from the first LUT based on the gray scale of the preceding frame N−1 and the gray scale of the next frame N. The second LUT in some embodiments may store actual gray scales of the preceding frame N−1 of a LCD having higher refresh frequency than 60 HZ. The first LUT and the second LUT can be set based on experimental data. Therefore, LCDs or LCD panels having different parameters (such as different refresh frequencies) may have different first and second LUTs respectively.

Referring to FIG. 8, when the liquid crystal molecule switches from a first frame (the preceding frame N−1)to a second frame (the next frame N), the second gray scale of the next frame N is received and is compared with the first gray scale of the preceding frame N−1 extracted from a memory. Then, the overdrive gray scale is obtained from the first LUT to perform a first overdrive operation. After the first overdrive operation, the actual gray scale of the next frame N is obtained from the second LUT according to the target gray scale thereof in the first overdrive operation. When the liquid crystal molecule switches from the next frame N to a succeeding frame N+1, the actual gray scale of the next frame N is compared with a third gray scale of the succeeding frame N+1 to obtain the overdrive gray scale needed in a second overdrive operation from the first LUT.

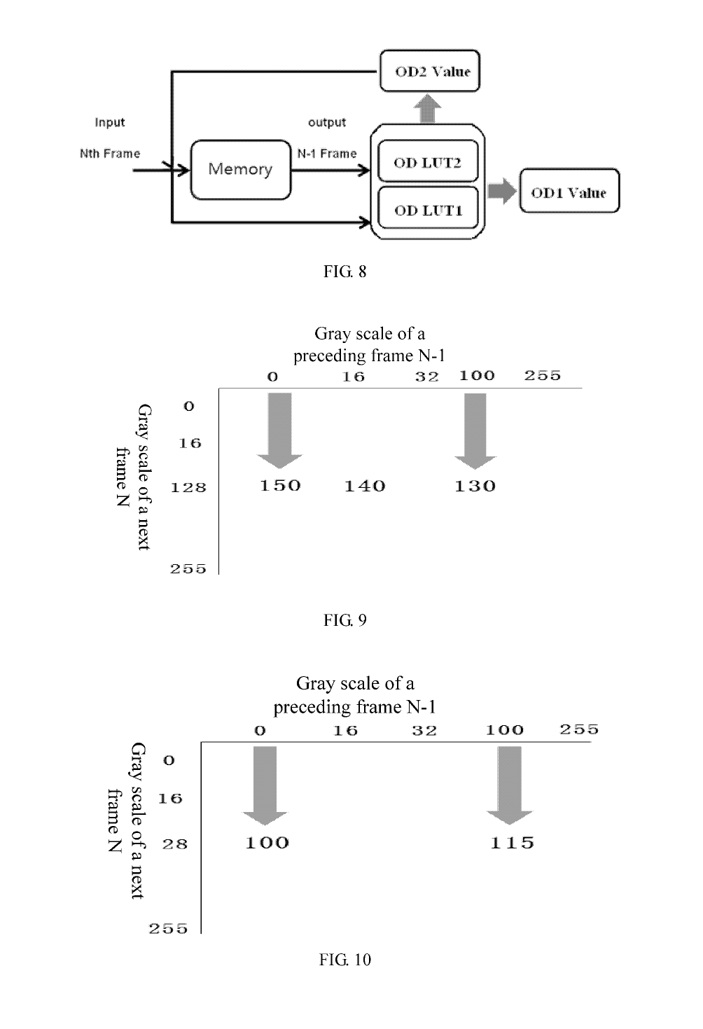

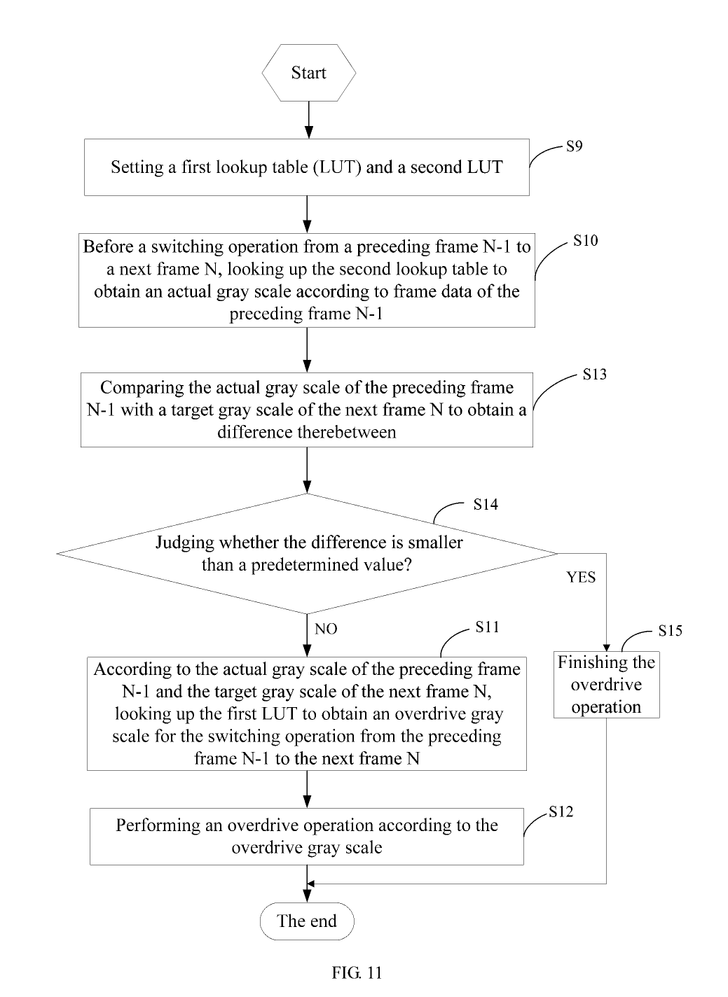

Referring to FIGS. 9 and 10, for example, to the LCD having the refresh frequency of 60 HZ, in the switching operation between four frames ranged in order, when the gray scales of the four frames are respectively as the following expression 0→128→128→128, the overdrive operations can be described as 0→150→128→128, and the actual gray scales of the liquid crystal molecule after the overdrive operations are as the following expression 0→128→128→128. That is, the actual gray scale of the liquid crystal molecule is capable of reaching the corresponding target gray scale.

However, to the LCD having the refresh frequency of 240 HZ, the overdrive operations corresponding to the gray scales of the four frames can be described as 0→150→128→128, and the actual gray scales of the liquid crystal molecule after the overdrive operations are as the followings expression 0→100→115→128. From the above expression, it can be concluded that when the LCD has a high refresh frequency, the actual gray scale of the liquid crystal molecule cannot reach the target gray scale thereof after the corresponding overdrive operation, which not only influences the effect of the overdrive operation but also prevents displayed images on the LCD from reaching the predetermined brightness level. With the driving method of the present disclosure, the actual gray scale of the liquid crystal molecule after the first overdrive operation can be corrected to obtain a suitable overdrive gray scale for a next overdrive operation, which improves the display effect of the LCD.

Specifically, to the LCD having the refresh frequency of 240 HZ, when the liquid crystal molecule switches from the first gray scale 0 (of the preceding frame N−1) to the second gray scale 128 (of the next frame N), a first overdrive gray scale 150 (higher than the second gray scale 128) needed for the first overdrive operation is obtained from the first LUT. However, since in the LCD having a frequency of 240 HZ, the time span of each frame is too short (4.5 ms) to allow the liquid crystal molecule to rotate over the predetermined angle in the time span, the actual gray scale of the liquid crystal molecule cannot reach the second gray scale 128 after the first overdrive operation. The actual gray scale of the liquid crystal molecule in some situations may be only about 100 (the actual gray scale may be obtained based on experimental detect). Since the actual gray scale of liquid crystal molecule is recognized to be 128, and the gray scale of the succeeding frame N+1 is also 128, therefore, there is no overdrive operation performed for the switching operation from the second gray scale 128 to the third gray scale 128.

In the driving method of the present disclosure, after the first overdrive operation, the actual gray scale of the next frame N is obtained from the second LUT and further is corrected before the switching from the next frame N to the succeeding frame N+1. For example, the actual gray scale of the next frame N obtained from the second LUT is only 100 after the first overdrive operation, which is less than the target gray scale 128 of the next frame N. Therefore, the target gray scale 128 is corrected to be 100.

An overdrive gray scale 130 corresponding to the corrected target gray scale 100 is obtained from the first LUT table to allow a second overdrive operation to be performed. Similarly, after the second overdrive operation, the actual gray scale 115 of the succeeding frame N+1 is obtained from the second LUT, and an overdrive gray scale of 128 corresponding to the actual gray scale 115 of the succeeding frame N+1 is used for performing the third overdrive operation. Therefore, the effect of the overdrive operations can be corrected with the second LUT table, which improves the effect of the overdrive operation.

Referring to FIG. 11, in a third embodiment, the driving method further includes the following steps before the step of S11:

In step S13, comparing with the actual gray scale of the preceding frame N−1 with the target gray scale of the next frame N to obtain a difference therebetween.

In step S14, judging whether the difference is smaller than a predetermined value, if yes, goes to the step of S14, if no, returns to the step of S11.

In step S15, finishing the overdrive operation.

In the switching operation from the preceding frame N−1 to the next frame N, if the gray scales of the two frames are close to each other, the gray scale of the next frame N may become two high after the second overdrive operation. Therefore, after the corrected actual gray scale is obtained from the second LUT, the corrected actual gray scale can be compared with the third gray scale of the succeeding frame N+1. If the difference between the corrected gray scale and the third gray scale is smaller than the predetermined value (for example, smaller than 5), no overdrive operation is performed to prevent the display effect of the LCD from being affected.

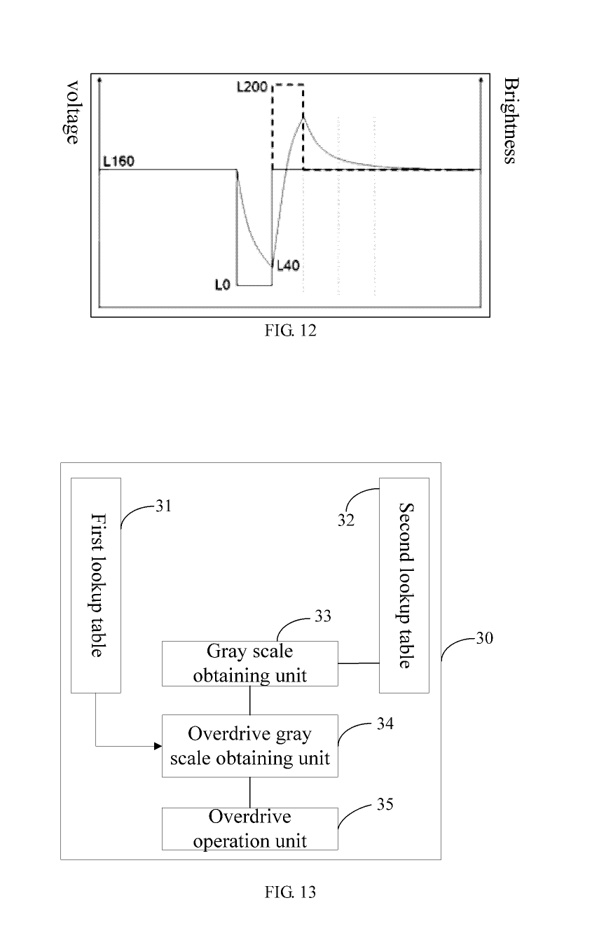

With the second LUT, error signals can further be eliminated. Take the switching operation 160→0→160→0 as an example, when the liquid crystal molecule switches from the first gray scale 160 to the second gray scale 0, the overdrive gray scale 0 obtained from the first LUT is inputted to perform the first overdrive operation. Since the time span of each frame is short, the liquid crystal molecule cannot rotate over the predetermined angle in the time span to allow the gray scale to be 0. Assume that after the time span of the each frame, the actual gray scale of the liquid crystal molecule is 40. However, in the conventional overdrive operation, the actual gray scale of the liquid crystal molecule is recognized as 0 by the system of the LCD. In this situation, an overdrive gray scale 200 is obtained from the first LUT to allow the liquid crystal molecules to switch from 0 to 160 in the second overdrive. Since the actual gray scale is 40 and the suitable overdrive gray scale for the switching operation the gray scale 40 to 160 is 180, therefore, the overdrive gray scale 200 is overvalued. In this situation, the boundary of the moving image can easily produce a bright flange and a dark flange. Referring to FIG. 12, at this time, the actual gray scale of the liquid crystal molecule after the second overdrive operation is higher than a desired level, making the brightness of a displayed image be higher than a predetermined brightness level. For example, a line which is to be displayed in the LCD may have a gray scale higher than 160 which is the original gray scale of the line. With the driving method of the present disclosure, the actual gray scale 0 is corrected to be 40 after the first overdrive operation. Therefore, a suitable overdrive gray scale of 180 can be obtained from the first LUT for the switching operation from the gray scale 40 to 160.

Referring to FIG. 13, a LCD in accordance with a first embodiment is provided. The LCD includes the first LUT, the second LUT, a gray scale obtaining unit, an overdrive gray scale obtaining unit, and an overdrive operation unit. The gray scale obtaining unit is used for obtaining the actual gray scale of the preceding frame N−1 from the second LUT based on the frame data thereof before the liquid crystal molecule switches from the preceding frame N−1 to the next frame N. The frame data at least includes the gray scale information of the frame. The overdrive gray scale obtaining unit is used for obtaining the overdrive gray scale from the first LUT based on the actual gray scale of the preceding frame N−1 and the gray scale of the next frame N. The overdrive voltage driving unit is used for performing the overdrive operation based on the overdrive gray scale.

With the second LUT of the LCD of the present disclosure, the gray scale of the preceding frame N−1 is corrected before the overdrive operation, and the display effect of the LCD is improved.

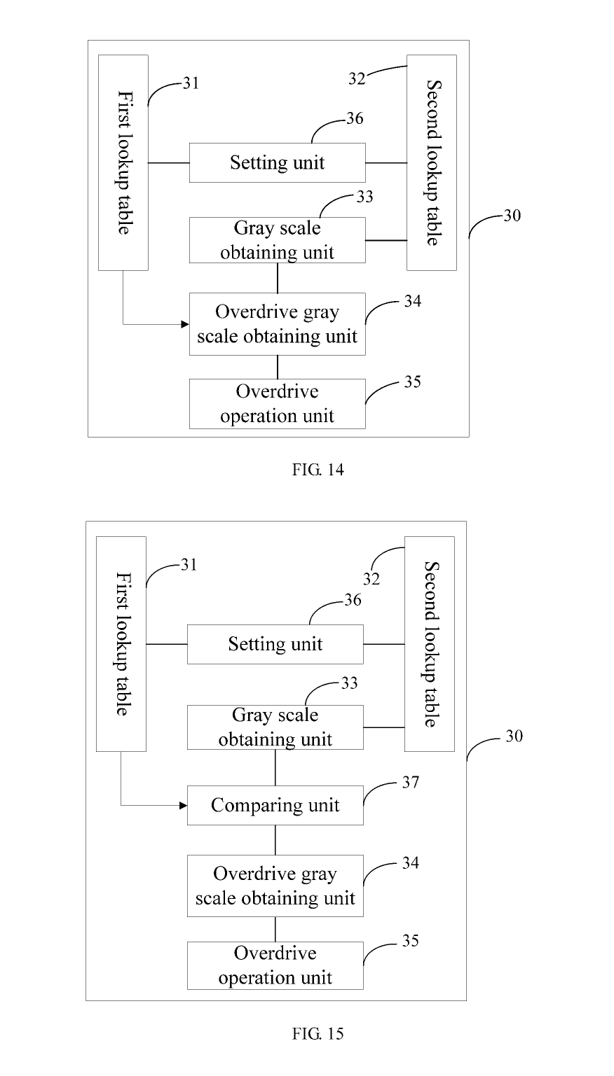

Referring to FIG. 14, in a second embodiment, the LCD further includes a setting unit for setting the first and second LUTs. The first LUT can be a conventional LUT used in the conventional overdrive operation. In the overdrive operation, a corresponding overdrive gray value can be obtained from the first LUT based on the gray scale of the preceding frame N−1 and the gray scale of the next frame N. The second LUT in some embodiments may store actual gray scales of the preceding frame N−1 of a LCD having higher refresh frequency than 60 HZ. The first LUT and the second LUT can be set based on experimental data. Therefore, LCDs or LCD panels having different parameters (such as different refresh frequencies) may have different first and second LUTs respectively.

Referring to FIG. 8, when the liquid crystal molecule switches from a first frame (the preceding frame N−1)to a second frame (the next frame N), the second gray scale of the next frame N is received and is compared with the first gray scale of the preceding frame N−1 extracted from a memory. Then, the overdrive gray scale is obtained from the first LUT to perform a first overdrive operation. After the first overdrive operation, the actual gray scale of the next frame N is obtained from the second LUT according to the target gray scale thereof in the first overdrive operation. When the liquid crystal molecule switches from the next frame N to a succeeding frame N+1, the actual gray scale of the next frame N is compared with a third gray scale of the succeeding frame N+1 to obtain the overdrive gray scale needed in a second overdrive operation from the first LUT.

Referring to FIGS. 9 and 10, for example, to the LCD having the refresh frequency of 60 HZ, in the switching operation between four frames ranged in order, when the gray scales of the four frames are respectively as the following expression 0→128→128→128, the overdrive operations can be described as 0→150→128→128, and the actual gray scales of the liquid crystal molecule after the overdrive operations are as the following expression 0→128→128→128. That is, the actual gray scale of the liquid crystal molecule is capable of reaching the corresponding target gray scale.

However, to the LCD having the refresh frequency of 240 HZ, the overdrive operations corresponding to the gray scales of the four frames can be described as 0→150→128→128, and the actual gray scales of the liquid crystal molecule after the overdrive operations are as the followings expression 0→100→115→128. From the above expression, it can be concluded that when the LCD has a high refresh frequency, the actual gray scale of the liquid crystal molecule cannot reach the target gray scale thereof after the corresponding overdrive operation, which not only influences the effect of the overdrive operation but also prevents displayed images on the LCD from reaching the predetermined brightness level. With the driving method of the present disclosure, the actual gray scale of the liquid crystal molecule after the first overdrive operation can be corrected to obtain a suitable overdrive gray scale for a next overdrive operation, which improves the display effect of the LCD.

Specifically, to the LCD having the refresh frequency of 240 HZ, when the liquid crystal molecule switches from the first gray scale 0 (of the preceding frame N−1) to the second gray scale 128 (of the next frame N), a first overdrive gray scale 150 (higher than the second gray scale 128) needed for the first overdrive operation is obtained from the first LUT. However, since in the LCD having a frequency of 240 HZ, the time span of each frame is too short (4.5 ms) to allow the liquid crystal molecule to rotate over the predetermined angle in the time span, the actual gray scale of the liquid crystal molecule cannot reach the second gray scale 128 after the first overdrive operation. The actual gray scale of the liquid crystal molecule in some situations may be only about 100 (the actual gray scale may be obtained based on experimental detect). Since the actual gray scale of liquid crystal molecule is recognized to be 128, and the gray scale of the succeeding frame N+1 is also 128, therefore, there is no overdrive operation performed for the switching operation from the second gray scale 128 to the third gray scale 128. With the driving method of the present disclosure, the actual gray scale 0 is corrected to be 40 after the first overdrive operation. Therefore, a suitable overdrive gray scale of 180 can be obtained from the first LUT for the switching operation from the gray scale 40 to 160.

Referring to FIG. 15, in a third embodiment, the LCD further includes a comparing unit. The comparing unit compares the actual gray scale of the preceding frame N−1 with the target gray scale of the next frame N to obtain a difference therebetween, judges whether the difference is smaller than the predetermined value (such as 5), and finishes the overdrive operation if the predetermined value is smaller than the predetermined value to allow the display effect of the LCD to be affected.

In the switching operation from the preceding frame N−1 to the next frame N, if the gray scales of the two frames are close to each other, the gray scale of the next frame N may become two high after the second overdrive operation. Therefore, after the corrected actual gray scale is obtained from the second LUT, the corrected actual gray scale can be compared with the third gray scale of the succeeding frame N+1. If the difference between the corrected gray scale and the third gray scale is smaller than the predetermined value (for example, smaller than 5), no overdrive operation is performed to prevent the display effect of the LCD from being affected.

With the second LUT, error signals can further be eliminated. Take the switching operation 160→0→160→0 as an example, when the liquid crystal molecule switches from the first gray scale 160 to the second gray scale 0, the overdrive gray scale 0 obtained from the first LUT is inputted to perform the first overdrive operation. Since the time span of each frame is short, the liquid crystal molecule cannot rotate over the predetermined angle in the time span to allow the gray scale to be 0. Assume that after the time span of the each frame, the actual gray scale of the liquid crystal molecule is 40. However, in the conventional overdrive operation, the actual gray scale of the liquid crystal molecule is recognized as 0 by the system of the LCD. In this situation, an overdrive gray scale 200 is obtained from the first LUT to allow the liquid crystal molecules to switch from 0 to 160 in the second overdrive. Since the actual gray scale is 40 and the suitable overdrive gray scale for the switching operation the gray scale 40 to 160 is 180, therefore, the overdrive gray scale 200 is overvalued. In this situation, the boundary of the moving image can easily produce a bright flange and a dark flange. Referring to FIG. 12, at this time, the actual gray scale of the liquid crystal molecule after the second overdrive operation is higher than a desired level, making the brightness of a displayed image be higher than a predetermined brightness level. For example, a line which is to be displayed in the LCD may have a gray scale higher than 160 which is the original gray scale of the line.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A driving method for a liquid crystal display, comprising the following steps:
before a switching operation from a preceding frame to a next frame, looking up a preset second lookup table to obtain an actual gray scale of the preceding frame according to frame data of the preceding frame, the frame data of the preceding frame at least comprising a gray scale of the preceding frame;
according to the actual gray scale of the preceding frame and a predetermined gray scale of the next frame, looking up a preset first lookup table to obtain an overdrive gray scale corresponding to the switching operation from the preceding frame to the next frame;
performing an overdrive operation according to the overdrive gray scale.

2. The driving method as claimed in claim 1 further comprises the step of setting the first lookup table and the second lookup table before the step of obtaining the actual gray scale of the preceding frame from the second lookup table.

3. The driving method as claimed in claim 1, wherein the first lookup table stores the overdrive gray scale of the overdrive operation corresponding to the switching operation from the preceding frame to the next frame, and the second lookup table stores contrary information used for correcting the gray scale of the liquid crystal molecule in the overdrive operation of the LCD having a high refresh frequency.

4. The driving method as claimed in claim 1, wherein the information stored in the second lookup table is obtained by experimental detects.

5. The driving method as claimed in claim 1 further comprises the following steps:
comparing the actual gray scale of the preceding frame with a target gray scale of the next frame to obtain a difference therebetween;
judging whether the difference is smaller than a predetermined value or not;
finishing the overdrive operation if the difference is smaller than the predetermined value.

6. The driving method as claimed in claim 2 further comprises the following steps:
comparing the actual gray scale of the preceding frame with the target gray scale of the next frame to obtain a difference therebetween;
judging whether the difference is smaller than a predetermined value or not;
finishing the overdrive operation if the difference is smaller than the predetermined value.

7. The driving method as claimed in claim 3 further comprises the following steps:
comparing the actual gray scale of the preceding frame with the target gray scale of the next frame N to obtain a difference therebetween;
judging whether the difference is smaller than a predetermined value or not;
finishing the overdrive operation if the difference is smaller than the predetermined value.

8. The driving method as claimed in claim 5, wherein the predetermined value is 5.

9. A liquid crystal display, comprising:
a preset first lookup table and a preset second lookup table;
a gray scale obtaining unit for obtaining an actual gray scale of a preceding frame from the second lookup table according to frame data of the preceding frame before a switching operation from the preceding frame to the next frame, the frame data at least comprising a gray scale of preceding frame;
an overdrive gray scale obtaining unit for obtaining an overdrive gray scale used in the switching operation from the preceding frame to the next frame according to the actual gray scale of the preceding frame and a target gray scale of the next frame;
an overdrive operation unit for performing the overdrive operation according to the overdrive gray scale.

10. The liquid crystal display as claimed in claim 9 further comprises a setting unit for setting the first lookup table and the second lookup table.

11. The liquid crystal display as claimed in claim 9, wherein the first lookup table stores the overdrive gray scale of the overdrive operation corresponding to the switching operation from the preceding frame to the next frame, and the second lookup table stores contrary information used for correcting the gray scale of the liquid crystal molecule in the overdrive operation of the LCD having a high refresh frequency.

12. The liquid crystal display as claimed in claim 9, wherein the information stored in the second lookup table is obtained by experimental detects.

13. The liquid crystal display as claimed in claim 9 further comprises a comparing unit for comparing the actual gray scale of the preceding frame with the target gray scale of the next frame to obtain a difference therebetween; judging whether the difference is smaller than a predetermined value or not; and finishing the overdrive operation if the difference is smaller than the predetermined value.

14. The liquid crystal display as claimed in claim 10 further comprises a comparing unit for comparing the actual gray scale of the preceding frame with the target gray scale of the next frame to obtain a difference therebetween; judging whether the difference is smaller than a predetermined value or not; and finishing the overdrive operation if the difference is smaller than the predetermined value.

15. The liquid crystal display as claimed in claim 11 further comprises a comparing unit for comparing the actual gray scale of the preceding frame with the target gray scale of the next frame to obtain a difference therebetween; judging whether the difference is smaller than a predetermined value or not; and finishing the overdrive operation if the difference is smaller than the predetermined value.

16. The liquid crystal display as claimed in claim 9, wherein the predetermined value is 5.

17. A liquid crystal display, comprising:
a setting unit for setting a first lookup table and a second lookup table, the first lookup table storing the overdrive gray scale of the overdrive operation corresponding to a switching operation from the preceding frame to the next frame, and the second lookup table storing contrary information used for correcting the gray scale of the liquid crystal molecule in the overdrive operation of the LCD having a high refresh frequency;
a gray scale obtaining unit for obtaining an actual gray scale of a preceding frame from the second lookup table according to frame data of the preceding frame before the switching operation from the preceding frame to the next frame, the frame data at least comprising a gray scale of preceding frame;
an overdrive gray scale obtaining unit for obtaining an overdrive gray scale used in switching operation from the preceding frame to the next frame according to the actual gray scale of the preceding frame and a target gray scale of the next frame;
an overdrive operation unit for performing the overdrive operation according to the overdrive gray scale.

18. The liquid crystal display as claimed in claim 17, wherein the information stored in the second lookup table is obtained by experimental detects.

19. The liquid crystal display as claimed in claim 17 further comprises a comparing unit for comparing the actual gray scale of the preceding frame with the target gray scale of the next frame to obtain a difference therebetween, judging whether the difference is smaller than a predetermined value or not; and finishing the overdrive operation if the difference is smaller than the predetermined value.

20. The liquid crystal display as claimed in claim 19, wherein the predetermined value is 5.
